(19) United States
(12) Patent Application Publication
(10) Pub. No.: US 2012/0135658 A1
(43) Pub. Date: May 31, 2012

(54) PROTECTIVE ARTICLE AND METHODS OF MANUFACTURE THEREOF

(75) Inventors: Joshua James Stone, Worcester, NY (US); Gary Charles Davis, Albany, NY (US); Vishal Bansal, Overland Park, KS (US)

(73) Assignee: GENERAL ELECTRIC COMPANY, Schenectady, NY (US)

(21) Appl. No.: 12/241,806

(22) Filed: Sep. 30, 2008

(51) Int. Cl. B32B 27/12; B32B 27/34; B32B 27/36; B32B 5/16; B32B 3/26; B32B 15/088; B32B 15/09; B32B 15/08; B05D 1/36; B32B 27/00

(52) U.S. Cl. 442/286; 427/202; 427/201; 428/474.4; 428/480; 428/500; 428/304.4; 428/421; 428/457; 428/458; 428/461; 428/328; 442/394

(57) ABSTRACT

An article comprises a first layer which includes a substrate and a nucleophilic organic polymer cross-linked on a surface of or within the substrate. The cross-linked nucleophilic polymer comprises functional groups operative to form a covalent bond with a chemical or biological agent. The first layer also includes reactive particles located on a surface of or within the substrate.

### FEDERAL RESEARCH STATEMENT

This invention was made with Government support under Contract No. W911-QY-05-C-0102 awarded by the U.S. Army Soldier Systems Center. The Government has certain rights in the invention.

### BACKGROUND

This disclosure is related to protective suits and methods of manufacture thereof. More specifically, this disclosure relates to chemical-biological protective suits and methods of manufacture thereof.

Chemical-biological protective suits are worn when the surrounding environment may present a potential hazard of exposing an individual to harmful or noxious chemicals, and/or to potentially harmful or fatal biological agents. Exposure to such agents may be the result of accidental release in a chemical manufacturing plant, in a scientific or medical laboratory, or in a hospital; intentional release by a government to attack the military forces of the opposition; and/or release during peacetime by criminal or terrorist organizations with the purpose of creating mayhem, fear, and widespread destruction. For these reasons, the development of reliable, adequate protection against chemical and biological warfare agents is desirable.

Historically, the materials used for chemical-biological protective suits have had to trade comfort for protection. That is, those offering more protection were unacceptably uncomfortable, and those being of satisfactory comfort did not offer acceptable protection.

The development of materials that provide adequate protection from harmful chemical or biological agents by restricting the passage of such agents has resulted in the production of materials that characteristically prevent the passage of water vapor. A material that to a substantial extent prevents the transmission of water vapor is termed unbreathable. Due to their unbreathable nature, the use of these materials retards the ability of the human body to dissipate heat through perspiration, resulting in the development of heat stress burden on the wearer. For example, currently commercially available materials generally produce a heat stress burden on the soldier wearing the suit.

Further, currently commercially available chemical and biological protective suits also lack a mechanism to detoxify chemical and biological agents. These types of suits possess adsorptive chemical protective systems that act by adsorbing hazardous liquids and vapors into absorbants thus passively inhibiting them from reaching the individual they are designed to protect. However, a limiting characteristic of these absorbants is that they have a finite ability to adsorb chemicals. A second limiting characteristic of absorbants is that they will indiscriminately adsorb chemical species for which protection is unnecessary, thus reducing the available capacity for adsorption of the chemicals to which they were intended to provide protection. It is therefore desirable to have protective suits that are lightweight, breathable, robust, and ultimately self-detoxifying against specific agents that are known to present serious threats.

### SUMMARY

In one embodiment, an article comprises a first layer which includes a substrate and a nucleophilic organic polymer cross-linked on a surface of or within the substrate. The cross-linked nucleophilic polymer comprises functional groups operative to form a covalent bond with a chemical or biological agent. The first layer may also include reactive particles located on a surface of or within the substrate.

In another embodiment, a method of manufacturing an article comprises crosslinking a nucleophilic organic polymer on a surface of or within a substrate. The cross-linked nucleophilic polymer comprises functional groups operative to form a covalent bond with a chemical or biological agent. Reactive particles are disposed on a surface of or within the substrate, wherein the nucleophilic organic polymer, reactive particles and substrate form a first layer.

### BRIEF DESCRIPTION OF THE DRAWINGS

FIG. 1 provides an illustration of the bonding that occurs between a chemically reactive group on a nucleophilic polymer, in this case ethoxylated polyethyleneimine (PEI-OH), and a chemical agent such as sarin;

FIG. 2 shows a schematic layering of the composite material that comprises the first layer and an optional second layer;

FIG. 3 is an illustration of a multi-layered composite material comprising a first layer, a second layer, and a third layer;

FIG. 4 is an illustration of a multi-layered composite material comprising a first layer, a second layer, a third layer, and an additional activated carbon layer disposed between the first layer and the second layer;

FIG. 5 is an illustration of a multi-layered composite material comprising a first layer, a second layer, a third layer, and an additional activated carbon layer disposed between the second layer and the third layer;

FIG. 6 is an illustration of a multi-layered composite material comprising a first layer and a third layer, with an additional activated carbon layer disposed between the first layer and the third layer;

FIG. 7(a) is a graph illustrating the breakdown of diisopropyl fluorophosphonate (DFP) by an expanded polytetrafluoroethylene (ePTFE) membrane coated with polyethyleneimine.

FIG. 7(b) is a graph illustrating the breakdown of DFP by an expanded polytetrafluoroethylene (ePTFE) membrane coated with polyethyleneimine and CuAl₂O₄ particles.

### DETAILED DESCRIPTION

The terms “a” and “an” as used herein do not denote a limitation of quantity, but rather denote the presence of at least one of the referenced items. All ranges disclosed herein are inclusive and combinable.

The terms “comprises” and/or “comprising,” as used herein, specify the presence of stated features, integers, steps, operations, elements, and/or components, but do not preclude the presence or addition of one or more other features, integers, steps, operations, elements, components, and/or groups thereof.

As used herein, the term “biological agent” refers to a microorganism, such as a virus or bacteria, capable of causing morbidity or mortality in humans, or in animals. The term “biological agent” also encompasses toxins that are produced by such microorganisms, and which may be purified and used independently from the microorganism.

It will be understood that when an element or layer is referred to as being “on,” “interposed,” “disposed,” or “between” another element or layer, it can be directly on, interposed, disposed, or between the other element or layer, or intervening elements or layers may be present.

As used herein, the terms first, second, third, and the like may be used herein to describe various elements, components, regions, layers and/or sections, however, these elements, components, regions, layers and/or sections should not be limited by these terms. These terms are only used to distinguish one element, component, region, layer or section from another element, component, region, layer or section. Thus, first element, component, region, layer or section discussed below could be termed second element, component, region, layer or section without departing from the teachings of the present invention.

The present disclosure is directed to a composite material that is selectively impermeable to chemical and biological agents. The composite material described herein comprises one or more layers that are able to bind and deactivate chemical and/or biological agents. In an exemplary embodiment, the composite material comprises a plurality of layers that are able to absorb certain chemical and/or biological agents in addition to being capable of binding and deactivating other chemical and/or biological agents. The multilayered composite is used for the manufacture of protective coverings, including chemical-biological protective suits.

In one embodiment, the composite material is selectively permeable to radiological materials in a similar manner as described herein for chemical and biological agents.

In one embodiment, the composite material comprises a first layer that comprises a substrate and a nucleophilic organic polymer cross-linked on the surface of or within the substrate using a cross-linking agent. In one embodiment, the substrate is a porous substrate. Specifically, the substrate material is comprised of pores that are interconnected throughout the thickness of the material or surface from one side to the other. The presence of the pores allows for the movement of certain liquids or gases through the material. The pores may be open or closed cell pores. It is desirable for the composite material to have open cell pores. The nucleophilic organic polymer may be crosslinked within the pores of the porous substrate.

The substrate may be comprised of microporous membranes, casted thin films, textile fabrics (wovens or nonwovens), or a combination of any of these.

Various types of polymers can be used to form the substrate. Examples of polymers that can be used include those selected from the group consisting of polyolefins, polyamides, polycarbonates, cellulosic polymers, polyurethanes, polyesters, polyethers, polyacrylates, copolyether esters, copolyether amides, chitosan, fluoropolymers, and a combination comprising at least one of the foregoing polymers. Specifically, the substrate can comprise a fluoropolymer selected from the group consisting of polytetrafluoroethylene, poly(vinylidene fluoride), poly(vinylidene fluoride co-hexafluoropropylene), poly(tetrafluoroethylene oxide-co-difluoromethylene oxide, poly(tetrafluoroethylene-co-perfluoro(propylvinyl ether)), and a combination comprising at least one of the foregoing fluoropolymers. In a preferred embodiment, the substrate comprises polytetrafluoroethylene (PTFE), and even more specifically, expanded porous PTFE (ePTFE).

The substrate may be rendered porous by, for example, methods selected from the group consisting of perforating, stretching, expanding, bubbling, or extracting the substrate material, and a combination comprising at least one of the foregoing methods. Methods of making the porous substrate can also include foaming, skiving, or casting any of the materials. In one embodiment, the porous substrate is prepared by extruding a mixture of fine powder particles and lubricant. The calendered extrudate can be expanded or stretched in one or more directions to form fibrils that are connected to nodes, to form a 3-dimensional matrix or lattice type structure. In one embodiment the term “expanded” means stretched beyond the elastic limit of the material to introduce permanent set or elongation to the fibrils.

Continuous pores can be produced throughout the substrate. The porosity of the substrate can be greater than or equal to about 10 percent by volume of the substrate. Specifically, the porosity can be in a range of from about 10 percent to about 90 percent. The pore diameter can be uniform from pore to pore, and the pores can define a regular, periodic pattern. Alternatively, the pore diameter can differ from pore to pore, and the pores can define an irregular, aperiodic pattern. Combinations of pores that have regular, irregular, periodic and aperiodic patterns may also be used in the porous polymer substrate. The diameter of the pores can be less than or equal to about 50 micrometers (μm). Specifically, the diameter of the pores can be about 0.01 μm to about 50 μm.

The porous substrate can be a three-dimensional matrix or have a lattice-type structure comprising a plurality of nodes interconnected by a plurality of fibrils. Surfaces of the nodes and fibrils define a plurality of pores in the substrate,

In one embodiment, a polymerizable nucleophilic organic polymer and a cross-linking agent are disposed upon the substrate of the first layer. The nucleophilic organic polymer forms a thin coating or film on the surface of the substrate. Additionally, if the substrate is porous, a solution comprising the nucleophilic organic polymer can be used to partially or fully impregnate the pores of the substrate. The solution may also comprise reactive particles. If desired, upon coating, the nucleophilic organic polymer is cross-linked in situ to the surfaces of the substrate and/or within the substrate, e.g. within the pores of the substrate.

Suitable nucleophilic organic polymers are selected from the group consisting of polyalkyleneimines, for example, polyethyleneimine; polyamines, for example polyvinylamine, and polyallylamine; polyvinyl alcohols; polyesters, polyamides, polyalkylene glycol derivatives, for example, polyethylene glycol and polypropylene glycol derivatives and amine-substituted polyethylene and polypropylene glycols; polyacrylates, for example, amine-substituted and alcohol-substituted polyacrylates; functionalized olefin polymers; copolymers of polyvinylamine and polyvinylalcohol; and a combination comprising at least one of the foregoing nucleophilic polymers. Specifically, polyethyleneimines can be used including branched or linear polyethyleneimine, acylated polyethyleneimine, or ethoxylated polyethyleneimine. More specifically, ethoxylated polyethyleneimine (PEI-OH) can be used as the nucleophilic organic polymer.

The cross-linking agent used to cross-link the nucleophilic organic polymer is selected for its ability to cross-link the nucleophilic organic polymer and thereby facilitate the adhesion of the nucleophilic organic polymer to the substrate. In one embodiment, the cross-linking of the nucleophilic organic polymer prevents the removal of the cross-linked nucleophilic organic polymer from the substrate.

Examples of cross-linking agents include those selected from the group consisting of carbamates, blocked and unblocked isocyanates, polymeric polyepoxides, polybasic esters, aldehydes, formaldehydes and melamine formaldehydes, ketones, alkylhalides, organic acids, ureas, anhydrides, acyl halides, chloroformates, acrylonitrites, acrylates, methacrylates, dialkyl carbonates, thioisocyanates, dialkyl sulfates, cyanamides, haloformates, and a combination comprising at least one of the foregoing cross-linkers. Specifically, carbamates, also known as urethanes, may be used as cross-linking agents. For example, the cross-linking agent may be a 1,3,5-triazine carbamate. Examples of 1,3,5-triazine carbamate cross-linkers include tris-(butoxycarbonylamino)-1,3,5-triazine, tris-(methylcarbonylamino)-1,3,5-triazine, and mixed tris-substituted (methoxy/butoxycarbonylamino)-1,3,5-triazine systems. In a preferred embodiment, the cross-linking agent is a polyamide-epichlorohydrin, such as Polycup 172, available from Hercules, Inc.

The first layer also includes reactive particles located on a surface of the substrate or within the substrate. The reactive particles have the ability to react with a chemical and/or biological agent, and thereby deactivate the agent. The reactive particles may also have the ability to absorb certain chemical and/or biological agents. Specifically, the high surface area of the reactive particles provides reactive sites for the absorption and decontamination of chemical and/or biological agents to occur. In one embodiment, the reactive particles are dispersed within the thin coating or film comprising the nucleophilic organic polymer.

The reactive particles may be comprised of various materials including metals or metal oxides. For example, the reactive particles may be comprised of silver (Ag), gold (Au), platinum (Pt), palladium (Pd), iridium (Ir), tin (Sn), copper (Cu), anitmony (Sb), bismuth (Bi), zinc (Zn), or a combination comprising one or more of the foregoing metals. Examples of metal oxides the reactive particles may be comprised of include AgO, TiO₂, Al₂O₃, MgO, CuO, CuAl₂O₃, CeO₂, ZnO or a combination thereof. In a preferred embodiment, the reactive particles are comprised of silver or silver oxide.

The reactive particles may be any shape, including not limited to spherical, angular, or cylindrical. In one embodiment, the reactive particles have an average diameter in a range of from about 1 nm to about 10 microns. In one embodiment, the reactive particles have an average diameter in a range from about 1 nm to about 2000 nm. In one embodiment, the particles have an average diameter in a range of from about 3 nm to about 1000 nm. In another embodiment, the particles have an average diameter in a range of from about 5 nm to about 500 nm. In yet another embodiment, the particles have an average diameter in a range of from about 10 nm to about 200 nm.

In one embodiment, the nucleophilic organic polymer and the cross-linking agent are combined together in a solvent to form a solution, which is then applied to the substrate. The reactive particles may also be added to the solution before application of the solution to the substrate. The solution can be applied to the substrate using a variety of methods including dipping, spraying, padding, brushing, flowcoating, electrocoating, slot die coating, or electrostatic spraying. Specifically, slot die coating methods can be effectively used. Thereafter, the material may be cured by application of heat at a temperature and for a length of time sufficient to facilitate the cross-linking reaction, and to evaporate any residual solvent. The heating can occur in an oven following the coating process or, by setting the temperature of the rolls used in a roll-to-roll, or slot die process, to a level sufficient to both dry off the solvent and cross-link the nucleophilic organic polymer.

The nucleophilic organic polymer can be used in an amount of about 1 weight percent to about 95 weight percent based upon the total weight of the solution. Specifically, the nucleophilic organic polymer can be used in an amount of about 5 to about 60 weight percent, and more specifically in an amount of about 10 to about 50 weight percent. The cross-linker can be used in an amount of about 0.1 weight percent to about 50 weight percent based on the total weight of the solution. Specifically, the crosslinker can be used in an amount of about 1 to about 20 weight percent, and more specifically, in an amount of about 5 to about 15 weight percent.

The reactive particles can be used in an amount of about 0.1 weight percent to about 50 weight percent based upon the total weight of the solution. In another embodiment, the reactive particles can be used in an amount of about 0.5 to about 20 weight percent, and more specifically in an amount of about 0.5 to about 5 weight percent based on the total weight of the solution.

In one embodiment, the cross-linked nucleophilic polymer and reactive particles dispersed therein form a coating on the surface of the substrate. The thickness of the coating can vary in order to provide the desired degree of protection. Further, the thickness of the applied coating is directly related to the weight of the cross-linked nucleophilic polymer applied. Specifically, the weight of the coating applied to the substrate is about 1 to about 100 g/m², more specifically the weight is about 3 g/m² to about 50 g/m², and even more specifically from about 5 g/m² to about 40 g/m². The coating can be uniform in thickness or have a thickness that varies from one area to another. In another embodiment, the cross-linked nucleophilic polymer and reactive particles are impregnated within the pores of the substrate. In yet another embodiment, the cross-linked nucleophilic polymer and reactive particles can be simultaneously coated on both the surface of the substrate and within the pores of the substrate.

As described hereinabove, the cross-linking agent is selected for its ability to cross-link the nucleophilic organic polymer in order to facilitate the entanglement of the nucleophilic polymer on the substrate and/or in and around the pores of substrate, thereby forming a stable coating on the surface and/or within the pores of the substrate. Additionally, the cross-linking agent can also be selected for its ability to incorporate chemically reactive functional groups in the nucleophilic polymer. These functional groups have the ability to bind chemical or biological agents.

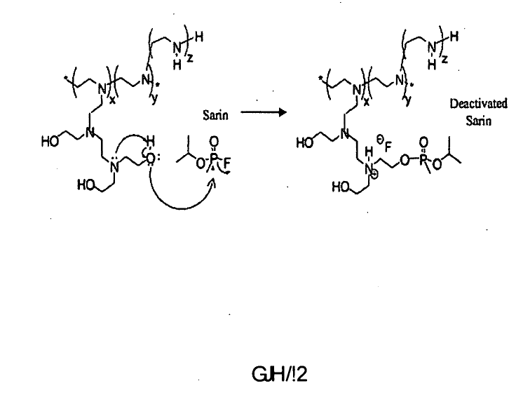

In one embodiment, the cross-linked nucleophilic organic polymer of the first layer comprises functional groups operative to form a covalent bond with a chemical or a biological agent. The binding of a chemical or biological agent can be to a reactive group present on the nucleophilic polymer prior to the cross-linking reaction. Alternatively, the binding of a chemical or biological agent can be to an unreacted functional group provided to the cross-linked nucleophilic polymer by the cross-linking agent. FIG. 1 provides an illustration of the covalent bonding that can occur between a chemically reactive group on a nucleophilic polymer, in this case ethoxylated polyethyleneimine (PEI-OH), and a chemical agent such as sarin. For example, as shown in FIG. 1, one possible mechanism is the hydrolysis of the nerve agent sarin and the formation of a covalent bond with the hydroxyl group on the PEI-OH molecule. Alternatively, the covalent bond between sarin and PEI-OE may form as a consequence of a nucleophilic attack by the nitrogen instead of the oxygen. As a result of this covalent interaction between the toxin and the cross-linked nucleophilic polymer, the sarin molecule is not only bound to the surface of the nucleophilic polymer, but is also deactivated, and is therefore no longer capable of exerting a toxic effect. Thus, rather than simply absorbing or blocking a chemical or biological agent, the first layer comprising a porous polymer substrate, cross-linked nucleophilic polymer, and reactive particles, is capable of deactivating agents that come into contact with the layer.

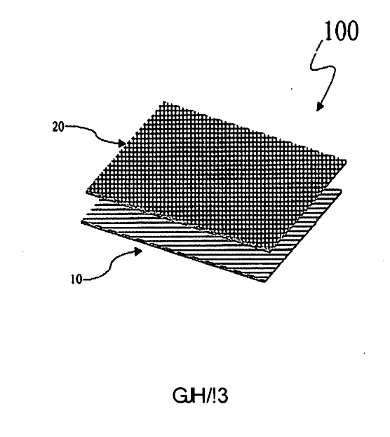

In one embodiment, the composite material comprises the first layer described above and an optional second layer adjacent to, or disposed on, the first layer. FIG. 2 shows a schematic layering of the composite material 100 that comprises the first layer 10 and the optional second layer 20.

The optional second layer 20 comprises a porous polymer substrate. The porous polymer substrate comprising the optional second layer 20 can be comprised of the same polymer material as is present in the first layer 10. Alternatively, the porous polymer substrate of the second layer 20 is made from a polymer that is different from the first layer 10. In one embodiment, the porous polymer substrate of the second layer 20 is unmodified i.e., it comprises a nucleophilic polymer that is not cross-linked on the surface or in the pores. In another embodiment, the second layer 20 includes a porous polymer substrate comprising a cross-linked nucleophilic organic polymer.

In one embodiment, the composite material comprises an optional third layer comprising a fabric material. The optional third layer is generally disposed on a surface of the second layer 20 that is opposed to the surface on which the first layer is disposed, i.e., the first layer and the third layer are disposed on opposing surfaces of the second layer. The fabrics of the third layer can be made from woven or non-woven material. Fabrics may be prepared from any synthetic or natural fiber appropriate for the specific end use in mind. Examples of fabrics include those used selected from the group consisting of polyamides, polyesters, cotton, aramids, and a combination comprising at least one of the foregoing fabrics. Specifically, the fabric can be a cotton/nylon mix in an amount of about 50 parts cotton to about 50 parts nylon and with a durable water-repellent finish.

Additional additives can be included in the composite material to further enhance the ability of the multilayered composite material to bind and inactivate chemical and biological agents. Examples of such agents include antimicrobial agents, enzymes with activity for known chemical and/or biological agents, and chemical absorbing agents. The additional additives can be selectively disposed upon the first, second or third layers.

In one embodiment, antimicrobial agents can be incorporated into one or more of the layers. As used herein, an “antimicrobial” agent is an agent that has antiviral (kills or suppresses the replication of viruses), antibacterial (bacteriostatic or bactericidal), and/or antifungal properties (kills or suppresses replication of fungi). Thus, the incorporation of one or more antimicrobial agents into the composite material provides an additional mechanism, acting in concert with the first layer, to kill, deactivate, or suppress the growth of microbial agents, such as bacteria, and viruses.

In one embodiment, antimicrobial compounds such as quaternary ammonium salts, N-halamines, antimicrobial metals and/or antimicrobial metal oxides can be coated directly on a surface of the first layer, or on a surface of the second layer, or optionally incorporated into the fabric of the third layer. Examples of quaternary ammonium salts having antimicrobial activity include those selected from the group consisting of tetraalkylammonium fluoroborates, alkylpyridinum fluoroborates, cetylpyridinium chloride (CPC), dodecyltrimethyl ammonium bromide (DTAB), N-(3-chloro-2-hydroxypropyl)-N,N-dimethyldodecylammonium chloride, 1,3-Bis-(N,N-dimethyldodecylammonium chloride)-2-propanol, dodecyltrimethyl ammonium chloride (DTAC), N-(1-(2,3-dioleoyloxy)propyl)-N,N,N-trimethylammonium chloride (DOTAP), N-(1-(2,3-dioleyloxy)propyl)-N,N,N-trimethylammonium chloride (DOTMA), dimethyldioctadecyl ammonium bromide (DDAB), N,N-dioleyl-N,N-dimethylammonium chloride (DODAC), 1,2-dioleoyloxy-3-(N,N,N-trimethylamino)propane chloride (DOTAP), and a combination comprising at least one of the foregoing quarternary salts. Examples of antimicrobial metals include those selected from the group consisting of silver (Ag), gold (Au), platinum (Pt), palladium (Pd), iridium (Ir), tin (Sn), copper (Cu), anitmony (Sb), bismuth (Bi), zinc (Zn), and a combination comprising one or more of the foregoing antibacterial metals. Specifically, antimicrobial metals such as Ag, Au, and Cu can be used. Alternatively, antimicrobial metal compounds can be used, and include those selected from the group consisting of metal oxides, metal-containing ion-exchange compounds, metal-containing, zeolites, metal-containing glass, and a combination comprising at least one of the foregoing metal compounds. Specifically, metal oxides can be used. Examples of metals oxides include those selected from the group consisting of AgO, TiO₂, Al₂O₃, MgO, CuO, and a combination comprising at least one of the foregoing metal oxides.

A “metallic stream” of antimicrobial metal or metal compound may be deposited onto the surface of the first and/or second layer in several different ways. Specifically, physical vapor deposition (PVD) techniques can be used to deposit the metals onto the surface of the first or second layer. Physical vapor deposition techniques deposit the metal from a vapor, generally atom by atom, onto a substrate surface. PVD techniques include, those selected from the group consisting of vacuum or arc evaporation, thermal vapor deposition, sputtering, and magnetron sputtering.

In another embodiment, the fabric used in the third layer can also be surface-treated with enzymes having activity for well-known chemical warfare agents. The enzymes can be selected for their ability to enzymatically degrade chemical agents such as sarin, soman, tabun, mustard agents, VX and Russian VX nerve agents. Examples of such enzymes include those selected from the group consisting of organophosphorus hydrolase (OPH), organophosphorus acid anhydrolase (OPAA), and diisopropylfluorophosphatase (DFPase) enzymes, and a combination comprising at least one of the foregoing enzymes. The aforementioned enzymes can be immobilized on the surface of the fabric used in the third layer and retain their ability to inactivate and/or degrade known chemical agents, thereby providing a preliminary layer of protection against such agents.

In yet another embodiment, an optional layer of chemically absorbent material such as activated carbon or a metal organic framework, is inserted in the composite material. The following description will make reference to an activated carbon layer, but it should be understood that an alternative chemically absorbent material, such as a metal organic framework can be used instead.

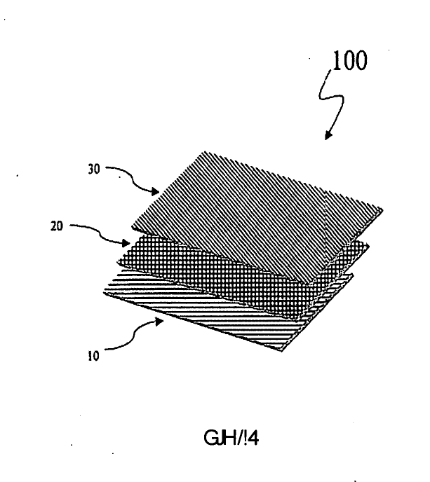

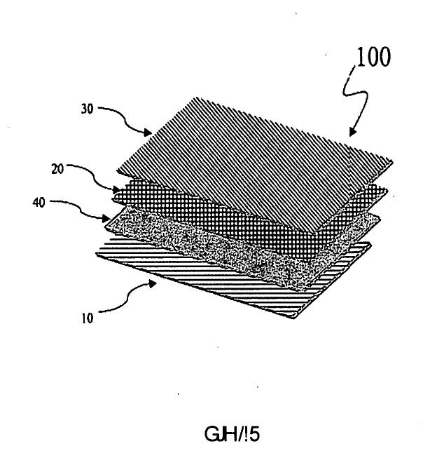

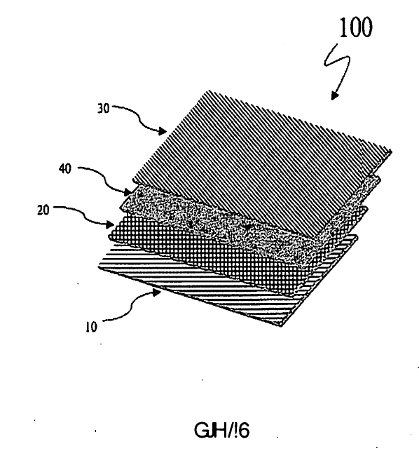

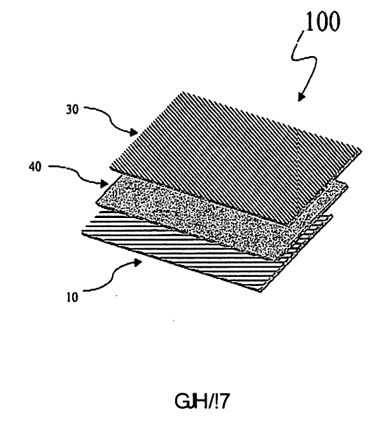

The activated carbon layer can be disposed on, or adjacent to, a single first layer (i.e., the activated carbon layer replaces the second or third layer); interposed between the first layer and an optional second layer; or interposed between a second layer and an optional third layer. Alternatively, in the absence of the optional second layer, the activated carbon layer is interposed between the first layer and the third layer. FIGS. 3, 4, 5, and 6 are schematic representations of the multilayered composite materials 100. In FIG. 3, the second layer 20 is interposed between the first layer 10 and the third layer 30 and contacts the first layer 10 and the third layer 30. FIG. 4 illustrates an activated carbon layer 40 interposed between the second layer 20 and the third layer 30, while FIG. 5 shows an alternate structure wherein the activated carbon layer 40 is interposed between the first layer 10 and the second layer 20. Finally, FIG. 6 shows the activated carbon layer interposed between the first layer 10 and the third layer 30.

The activated carbon can be impregnated in a carrier such as foam, fabric, felt, or paper, and in this form is termed activated carbon fiber (ACF). The activated carbon absorbers can be incorporated directly into the fibers of the carrier. Alternatively, spherical activated carbon absorbers can be adhered to a textile carrier with an adhesive binder or resin. ACF materials are characterized by their ability to absorb large volumes of gas, their heat-resistance, and by their resistance to both acids and bases. ACF materials are able to non-specifically absorb a wide variety of materials such as organic vapors, for example, gasoline, aldehydes, alcohols and phenol; inorganic gases, for example, NO, NO₂, SO₂, H₂S, HF, HCl, and the like; and substances in water solution, for example, dyes, COD, BOD, oils, metal ions, precious metal ions; and bacteria. Specifically, composite filter fabrics based on highly activated and hard carbon spheres fixed onto textile carrier fabrics, such as the SARATOGA™ fabrics can be used. Thus, the inclusion of an activated carbon layer can provide an additional barrier to noxious gases and thereby increase the ability of the composite material to filter out non-specific chemical agents.

In one embodiment, the composite material comprising at least one or more layers, is selectively permeable. For this reason, the composite material is able to effectively filter out chemical and biological agents while still maintaining a Moisture Vapor Transport Rate (“MVTR”) of about 1 to about 12 kilograms per square meter per 24 hours (kg/m²/24 h), specifically up to about 6 kg/m²/24 h, and more specifically up to about 8 kg/m²/24 h, while the transport rate of materials harmful to human health is low enough to prevent the occurrence of injury, illness, or death.

In another embodiment, the layered composite material can be used for the fabrication of, or as a component in, a variety of articles of manufacture, including articles of protective apparel, especially for clothing, garments or other items intended to protect the wearer or user against harm or injury as caused by exposure to toxic chemical and/or biological agents.

In yet another embodiment, the item of protective apparel is a chemical-biological protective suit useful to protect military personnel and first responders from known or unknown chemical or biological agents potentially encountered in an emergency response situation. Alternatively, the item is intended to protect cleanup personnel from chemical or biological agents during a hazardous material (HAZMAT) response situation or in various medical applications as protection against toxic chemical and/or biological agents.

Examples of items of protective apparel include those selected from the group consisting of coveralls, protective suits, coats, jackets, limited-use protective garments, raingear, ski pants, gloves, socks, boots, shoe and boot covers, trousers, hoods, hats, masks and shirts.

In another embodiment, the composite material can be used to create a protective cover, such as for example, a tarpaulin, or a collective shelter, such as a tent, to protect against chemical and/or biological warfare agents.

Articles comprising the composite material described herein have the ability to bind and deactivate a wide variety of chemical and biological agents. Examples of chemical agents include those selected from the group consisting of nerve agents, for example, Sarin, Soman, Tabun, and VX; vesicant agents, for example, sulfur mustards; Lewisites such as 2-chlorovinyldichloroarsine; nitrogen mustards; tear gases and riot control agents; and a combination comprising at least one of the foregoing chemical agents. Examples of potential biological agents include those selected from the group consisting of viruses, for example smallpox, encephalitis-causing viruses, and hemorrhagic fever-causing viruses; bacteria, for example, Yersinia pestis, Vibrio cholerae, Francisella tularensis, Rickettsia rickettsii, Bacillus anthracis, Coxiella burnetii and Clostridium botulinum; and toxins, for example, Ricin, Staphylococcal enterotoxin B, trichothecene mycotoxins, and Cholera toxins; and a combination comprising at least one of the foregoing biological agents. Examples of hazardous materials in addition to those listed above include certain pesticides, particularly organophosphate pesticides.

In one embodiment, a method is provided for manufacturing an article comprising the composite material. The layers of the composite material can be assembled together by any suitable means whereby the assembly is designed to perform as a whole that which the individual layers perform in part. Methods that can be used to manufacture an article from the composite material include, assembly of the layers with discontinuous bonds such as discrete patterns of adhesive or point bonding, mechanical attachments such as sewn connections or other fixations, fusible webs and thermoplastic scrims, direct coating on, or within, partially or entirely, the various layers in such a manner as they are intended to function in conjunction with one another.

Since the composite material described herein is both thinner and lighter than materials presently used for other commercially available suits, and since the MVTR of the composite material is good, articles manufactured from the composite material will be lighter and more comfortable to wear than those that are presently available. Combined with the ability of the composite material to bind and deactivate chemical and/or biological agents, articles made from the composite material will provide a comfortable and effective barrier for those in need of protection from hazardous agents.

### EXAMPLES

The following examples are intended only to illustrate methods and embodiments in accordance with the invention and as such should not be construed as imposing limitations upon the claims.

### Example 1

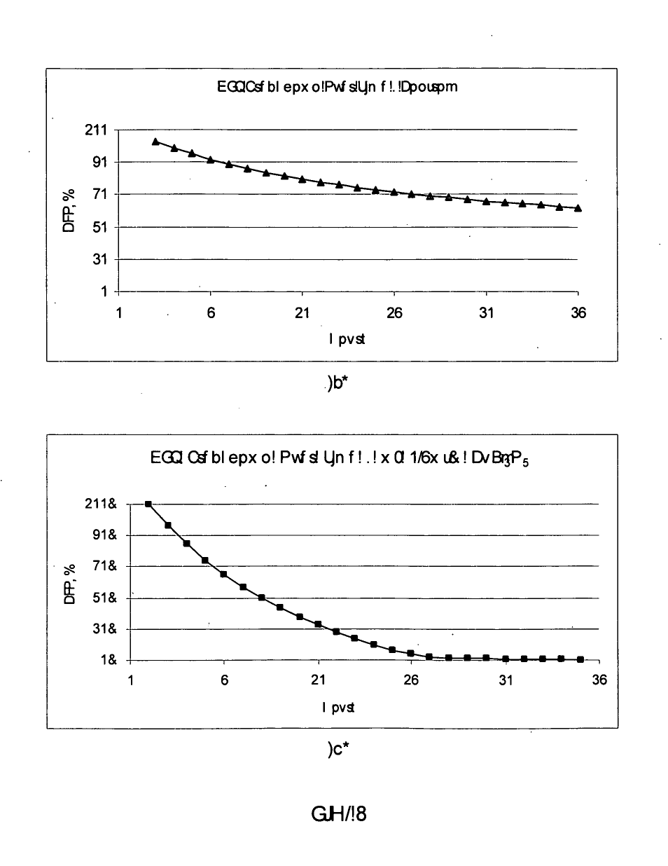

A 25 weight percent stock solution of branched polyethyleneimine is prepared in 2-propanol along with 20 weight percent of Cylink® 2000 crosslinking solution, available from Cytec Industries Inc. This solution is used to apply a coating via a slot die process onto an ePTFE membrane substrate at a coating level of ˜20 g/m² and cured for 10 minutes at 180 degrees Celsius. This material is used as the control. A second sample is prepared under identical conditions but using a version of the stock solution that contains 0.5 weight percent of CuAl₂O₄ nanoparticle powder mixed directly in using sonication and mechanical stirring for 10 minutes. These two materials are compared by ³¹P solid state NMR analysis where the decomposition of diisopropylfluorophosphate, a chemical simulate for Sarin agent, is monitored for 24 hours at a challenge level of 10 g/m². As illustrated in FIGS. 7(a) and 7(b), the coating comprising the polyethyleneimine and CuAl₂O₄ nanoparticles was more effective at decomposing diisopropylfluorophosphate than the coating comprising polyethyleneimine alone.

All ranges disclosed herein are inclusive of the endpoints, and the endpoints are combinable with each other. The terms “first,” “second,” and the like as used herein do not denote any order, quantity, or importance, but rather are used to distinguish one element from another. The modifiers “about” and “approximately” used in connection with a quantity are inclusive of the stated value and have the meaning dictated by the context (e.g., includes the degree of error associated with measurement of the particular quantity). The use of the terms “a” and “an” and “the” and similar referents in the context of describing the invention (especially in the context of the following claims) are to be construed to cover both the singular and the plural, unless otherwise indicated herein or clearly contradicted by context.

While the invention has been described in detail in connection with a number of embodiments, the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An article comprising:
a first layer comprising:
a substrate;
a nucleophilic organic polymer cross-linked on a surface of or within the substrate, wherein the cross-linked nucleophilic polymer comprises functional groups operative to form a covalent bond with a chemical or biological agent;
and reactive particles located on a surface of or within the substrate.

2. The article of claim 1, wherein the nucleophilic organic polymer is cross-linked using a polyamide-epichlorohydrin cross-linking agent.

3. The article of claim 1, wherein the nucleophilic organic polymer comprises a polymer selected from the group consisting of polyethyleneimine, polyamines, polyvinyl alcohols, polyesters, polyamides, polyalkylene glycol derivatives, amine-substituted polyethylene and polypropylene glycols, polyacrylates, functionalized olefin polymers, copolymers of polyvinylamine and polyvinylalcohol, and a combination comprising at least one of the foregoing nucleophilic polymers.

4. The article of claim 1, wherein the substrate is a porous polymer substrate.

5. The article of claim 1, wherein the substrate comprises polytetrafluoroethylene, poly(vinylidene fluoride), poly(vinylidene fluoride co-hexafluoropropylene), poly(tetrafluoroethylene oxide-co-difluoromethylene oxide, poly(tetrafluoroethylene-co-perfluoro(propylvinyl ether)), or a combination thereof.

6. The article of claim 1, wherein the reactive particles comprise silver, gold, platinum, palladium, iridium, tin, copper, anitmony, bismuth, zinc, or a combination comprising one or more of the foregoing metals.

7. The article of claim 1, wherein the reactive particles comprise silver oxide, titanium oxide, aluminum oxide, magnesium oxide, copper oxide, copper-aluminum oxide, cerium oxide, zinc oxide or a combination thereof.

8. The article of claim 1, wherein the reactive particles have an average diameter in a range between about 1 nm and about 10 microns.

9. The article of claim 1, wherein the reactive particles are dispersed within the nucleophilic organic polymer.

10. The article of claim 1, further comprising:
a second layer that comprises a porous polymer substrate, wherein the second layer is in contact with the first layer.

11. The article of claim 10, further comprising:
a third layer that comprises a woven or a non-woven fabric layer, wherein the third layer is in contact with the second layer.

12. The article of claim 1, further comprising an additive selected from the group consisting of antimicrobial agents, enzymes with activity for chemical and/or biological agents, chemical absorbing agents, and a combination comprising at least one of the foregoing additives.

13. The article of claim 12, wherein the chemical absorbing agent is activated carbon or a metal absorbing framework.

14. A method of manufacturing an article comprising:
crosslinking a nucleophilic organic polymer on a surface of or within a substrate, wherein the cross-linked nucleophilic polymer comprises functional groups operative to form a covalent bond with a chemical or biological agent; and
disposing reactive particles on a surface of or within the substrate;
wherein the nucleophilic organic polymer, reactive particles and substrate form a first layer.

15. The method of claim 14, further comprising disposing a second layer upon a surface of the first layer; the second layer comprising a porous polymer substrate.

16. The method of claim 15, further comprising disposing an additive on the second layer, wherein the additive is an antimicrobial agent, an enzyme with activity for neutralizing a chemical and/or a biological agent, or a chemical absorbing agent.

17. The method of claim 15, further comprising disposing a third layer upon a surface of the second layer, wherein the second layer is disposed between the first layer and the third layer.

18. The method of claim 17, wherein the third layer comprises a fabric, and wherein the fabric is selected from the group consisting of polyamides, polyesters, cotton, aramids, and a combination comprising at least one of the foregoing fabrics.

19. The method of claim 14, wherein the nucleophilic organic polymer is cross-linked using a polyamide-epichlorohydrin cross-linking agent.

20. The method of claim 14, wherein the nucleophilic organic polymer comprises a polymer selected from the group consisting of polyethyleneimine, polyamines, polyvinyl alcohols, polyesters, polyamides, polyalkylene glycol derivatives, amine-substituted polyethylene and polypropylene glycols, polyacrylates, functionalized olefin polymers, copolymers of polyvinylamine and polyvinylalcohol, and a combination comprising at least one of the foregoing nucleophilic polymers.

21. The method of claim 14, wherein the substrate comprises polytetrafluoroethylene, poly(vinylidene fluoride), poly(vinylidene fluoride co-hexafluoropropylene), poly(tetrafluoroethylene oxide-co-difluoromethylene oxide, poly(tetrafluoroethylene-co-perfluoro(propylvinyl ether)), or a combination thereof.

22. The method of claim 14, wherein the reactive particles comprise silver, gold, platinum, palladium, iridium, tin, copper, anitmony, bismuth, zinc, or a combination comprising one or more of the foregoing metals.

23. The method of claim 14, wherein the reactive particles comprise silver oxide, titanium oxide, aluminum oxide, magnesium oxide, copper oxide, copper-aluminum oxide, cerium oxide, zinc oxide or a combination thereof.

24. The method of claim 14, wherein the reactive particles have an average diameter in a range between about 1 nm and about 10 microns.

25. An article manufactured by the method of claim 14.
